(19) United States
(12) Patent Application Publication
(10) Pub. No.: US 2008/0231226 A1
(43) Pub. Date: Sep. 25, 2008

(54) Battery Powered Device

(75) Inventors: Peter F. Hoffman, Avon, OH (US); Joseph P. Gardner, North Ridgeville, OH (US); Daniel L. Stuckey, Avon Lake, OH (US); Craig S. Meyer, Fenton, MO (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: EVEREADY BATTERY COMPANY, INC., St. Louis, MO (US)

(21) Appl. No.: 11/690,185

(22) Filed: Mar. 23, 2007

(51) Int. Cl. H02J 7/00; F21L 4/08

(52) U.S. Cl. 320/103; 320/128

(57) ABSTRACT

A battery powered apparatus (100) includes an electrically powered device (124), a rechargeable energy storage device (112), and a battery receiving region (104) that receives at least a first battery (106). The electrically powered device (124) includes at least first and second operating modes. The operating mode of the device (124) is selected as a function of the state of charge of one or both the battery (106) and the rechargeable energy storage device (112).

### BACKGROUND

The present application relates to battery powered devices.

The proliferation of battery powered devices has increased dramatically in recent years, and this trend is expected to continue. A battery powered device such as a cell phone or other mobile communications device such as personal digital assistants (PDAs) typically include a secondary (rechargeable) battery that is built into the device to provide the needed power. In response to consumer demand, device manufacturers continue to incorporate additional features such as the ability to exchange text messages and e-mail and to take pictures. Unfortunately, these features usually increase the demand placed on the battery. The net result is that the devices' run times become shorter. At the same time, device manufacturers also continue to reduce device size and weight, thus tending to limit the space available for batteries. The confluence of these two trends has caused many device users to experience a dropped phone call or other interruption at an inopportune moment.

One response to this trend has been implementation of so-called hybrid battery management technology such as the known TEC103 integrated circuit that uses energy from external or other batteries to charge the rechargeable batteries in the device.

A related trend has seen the development of new technologies that present increasingly higher peak loads. For example, light emitting diodes (LEDs) have gained increasing acceptance in battery powered flashlights. While very effective in a wide variety of applications, conventional primary battery chemistries such as alkaline or carbon zinc perform relatively less well as the load or battery drain is increased. One particularly effective response to this situation has been the development of lithium iron disulfide (LiFeS₂) batteries, which perform especially well in high drain applications. Unfortunately, however suitable LiFeS₂ batteries may not be readily available for use in a particular device.

### SUMMARY

Aspects of the present application address these matters, and others.

According to a first aspect, a battery powered apparatus includes a rechargeable energy storage device, a battery receiving region, and an appliance that receives energy from the rechargeable energy storage device. The appliance includes a first operating mode and a second, relatively lower power operating mode. The apparatus also includes a circuit that uses energy from a battery received in the battery receiving region to charge the rechargeable energy storage device, a state of charge detector that detects a state of charge of the rechargeable energy storage device, and a mode controller that changes the operating mode of the appliance as a function of the detected state of charge.

According to another aspect, a method includes using energy from a battery received in a battery receiving region of a battery powered apparatus to charge a rechargeable energy storage device of the battery powered apparatus at a first rate, and using energy from the rechargeable energy source to operate an electrical appliance of the device in a first operating mode that discharges the rechargeable energy storage device at a second rate. The first rate is lower than second rate. The method also includes determining a state of charge of the rechargeable energy storage device and causing, as a function of the detected state of charge, the appliance to enter a second operating mode that discharges the rechargeable energy storage device at a third rate. The third rate is lower than the second rate.

According to another aspect, an apparatus includes a battery receiving region that receives a first battery, a rechargeable energy storage device that receives energy from the first battery, an appliance that receives energy from the rechargeable energy storage device and includes a first operating mode and an extended use operating mode, and a mode controller that causes the electrical appliance to enter the extended use mode based on a state of charge of at least one of the secondary energy storage device and the first battery.

Those skilled in the art will recognize still other aspects of the present application upon reading and understanding the attached description.

### BRIEF DESCRIPTION OF THE DRAWINGS

The present invention is illustrated by way of example and not limitation in the figures of the accompanying drawings, in which like references indicate similar elements and in which:

FIG. 1 depicts a battery powered apparatus.

FIG. 2 depicts an operation of a battery powered apparatus.

### DETAILED DESCRIPTION

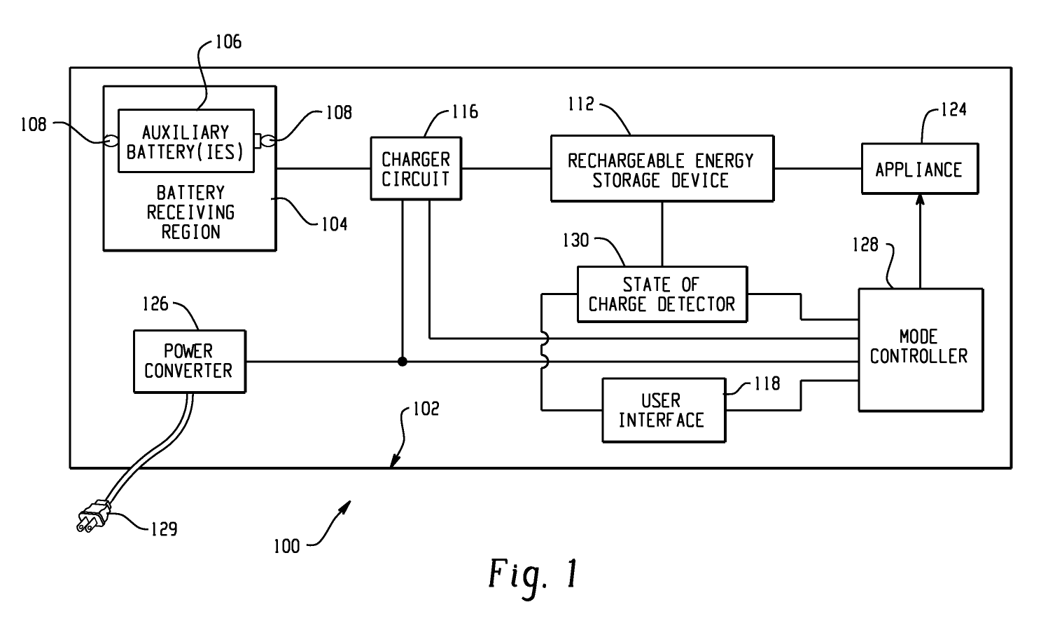

With reference to FIG. 1, a battery powered apparatus 100 includes a housing 102 that carries a rechargeable energy storage device 112, an auxiliary battery receiving region 104, and an electrically powered appliance 124. In one implementation, the rechargeable energy storage device 112 is disposed within the housing so as not to be readily replaceable by the user.

The auxiliary battery receiving region 104, which receives one or more auxiliary batteries 106 such as generally cylindrical AAA, AA, C, or D-size, coin cell, prismatic, or other batteries, is accessed via a cover that allows the user to readily replace the auxiliary batteries 106 as they become discharged. The auxiliary battery receiving region 104 also includes battery contacts 108 that make electrical contact with the terminals of the auxiliary batteries 106, with the number and configuration of the contacts 108 depending on the type and size of the battery or batteries 106 to be received in the battery receiving region 104.

The appliance 124, which receives operating power from the rechargeable energy storage device 112 and the auxiliary batteries 106, includes two or more operating states or modes in which the appliance 124 presents differing electrical loads. Thus, for example, the appliance 124 may include a first, high power operating mode and at least a second, lower power operating mode. The appliance 124 may also include one or more converter circuits that convert electrical energy from the rechargeable energy storage device 112 or auxiliary batteries 106 to the voltage and/or current levels required by the appliance 124. Note that the apparatus 100 may be configured so that the appliance operates even when auxiliary batteries 106 are not inserted in the battery receiving region 104 or have become discharged.

A converter or charger circuit 116 converts electrical energy from the auxiliary batteries 106 to voltage and/or current levels suitable for charging the rechargeable energy storage device 112. The circuit 116 operates in a first or low power mode and an optional second or high power mode. In the low power mode, the rate of charge of the secondary energy storage device 112 is limited so that the load presented to the auxiliary batteries 106 is less than their maximum rate capability. Viewed from the perspective of the rechargeable energy storage device 112 and the appliance 124, the charging circuitry 116 is configured so that the power available from the converter 116 is less than the power drawn by the appliance 124 when operating in its high power operating mode. Continued operation of the appliance 124 according to such an arrangement would thus result in the discharge of the rechargeable energy storage device 112.

The converter circuitry 116 may also be configured so that the available output power is less than the power drawn by the appliance 124 in one or more of the reduced power operating modes. Where the power provided by the converter circuit 116 is roughly equal to the power drawn by the appliance 124, the state of charge of the rechargeable energy storage device 112 would remain approximately constant. Continued operation of the appliance 124 according to such an arrangement would result in the discharge of the auxiliary batteries 106.

The above-described power or charge rate limiting may be achieved, for example, by limiting the current and/or voltage provided to the rechargeable energy storage device 112. In another implementation, the converter circuit 116 supplies a relatively higher instantaneous power to the rechargeable energy storage device 112, but at a reduced duty cycle. It will be appreciated, however, that the converter circuitry 116 preferably also operates when the appliance 124 is in an off or non-operating mode so that the rechargeable energy storage device 112 is charged during periods of non-use.

In the high rate mode, the converter circuit 116 supplies a relatively higher power to the rechargeable energy storage device 112. In one implementation, the power available from the converter circuit 116 is approximately equal to the power drawn by the appliance 124 when operating in its high power operating mode. Intermediate rate modes are also contemplated.

A user interface 118 allows the user to control the operation of and/or monitor the operation of the apparatus 100. Depending on the nature and function of the device, the user interface 118 may include input device(s) such as one or more knobs or switch(es), keypads, mice, touch screens, voice inputs, or the like. Alternatively or additionally, the user interface 118 may include output device(s) such as one or more visible, audible, tactile, or other human perceptible indicators. Some or all of the user interface 118 may also be integrated with the appliance 124.

A state of charge detector 130 produces an output indicative of the state of charge of the rechargeable energy storage device 112, for example by measuring the output voltage of the source 112, by measuring a current or energy drawn from the storage device 112 over time, by estimating the state of charge based on the operating mode and run time of the appliance 124, or by other suitable techniques either alone or in combination. Additionally or alternately, the state of charge detector may be used to detect the state of charge of the auxiliary batteries 106. In one implementation, the state of charge detector 130 generates a logical true or “low charge” signal when the state of charge is less than a threshold or other desired level. In another, the state of charge detector 130 produces a substantially continuous signal indicative of the state of charge. Stepwise or other similar outputs are also contemplated.

It will be appreciated that the “low charge” level is preferably established at a level where the secondary energy storage device 112, while relatively discharged, still contains sufficient energy to operate the appliance 112 for at least a limited period of time. Hence, the user may be afforded a warning or indication of an impending discharge so that the user may adjust the operation of the appliance 124 or his or her activities, replace the auxiliary batteries 106, switch to a secondary or different apparatus 100, or the like.

A mode controller 128 controls the operating mode(s) of the charger circuit 116 and/or the appliance 124 based on information from one or more of the state of charge detector 130 and the user interface 118. Operating modes for a first example configuration in which the user interface 118 is configured to allow the user to select high and low power operating modes of the appliance 124, the charger circuit 116 includes high and low power modes, and the user interface 118 includes a user override function, are shown in Table I:

TABLE I

| | RECHARGEABLE | | | |
|---|---|---|---|---|
| | ENERGY STORAGE | | | |
| | DEVICE STATE | USER | CHARGER | APPLIANCE |
| USER INPUT | OF CHARGE | OVERRIDE | CIRCUIT MODE | MODE |
| Appliance Off | Charge OK | X | Low Power | Off |
| Appliance Off | Low Charge | X | Low Power | Off |
| Appliance On - | Charge OK | X | Low Power | Appliance On - |
| Low Power | | | | Low Power |
| Appliance On - | Low Charge | X | Low Power | Appliance On - |
| Low Power | | | | Low Power |
| Appliance On - | Charge OK | No | Low Power | Appliance On - |
| High Power | | | | High Power |
| Appliance On - | Low Charge | No | Low Power | Appliance On - |
| High Power | | | | Low Power |
| Appliance On - | Low Charge | Yes | High Power | Appliance On - |
| High Power | | | | High Power |

where X means that the status of the user override function is not considered.

In the example of Table I, if the rechargeable energy storage device 112 is relatively charged, the appliance 124 would ordinarily operate as directed by the user via the user interface 118. As the rechargeable energy storage device 112 becomes discharged, the appliance 124 automatically switches to the low power mode. Note that this low power mode may be different than the low power mode ordinarily selected by the user. The user interface 118 may also be used to inform the user of an impending switch. If overridden by the user, however, the appliance 124 would return to the high power mode. Where, as illustrated, the charger circuit 116 includes a high rate mode, the user override would also cause the charger circuit 116 to operate in the high rate mode. Such an implementation is especially useful in applications where it is desirable to conserve or extend the operating time of the appliance 124 while providing the user with additional operating flexibility.

In another implementation, enabling the user override would cause the appliance 124 to remain in the high power state if the rechargeable energy storage device 112 becomes discharged. In such a case, the user interface 118 would ordinarily be configured to indicate to the user that the rechargeable energy storage device 112 has a relatively low charge and that the override function is active. Should the user elect to is disable the override, the appliance 124 would then switch to the low power operating mode. Such an implementation is especially useful where automatically switching the appliance 124 to a low power or extended use operating state could be inconvenient to the user.

Operating modes for a second example configuration in which the high and low power appliance operating modes are not explicitly selected by the user and where the charger circuit 116 does not include a high rate mode are shown in Table II:

TABLE II

| | RECHARGEABLE | | |
|---|---|---|---|
| | ENERGY | | |
| | STORAGE | | |
| | DEVICE STATE | USER | APPLIANCE |
| USER INPUT | OF CHARGE | OVERRIDE | MODE |
| Appliance Off | Charged | X | Off |
| Appliance Off | Discharged | X | Off |
| Appliance On | Charged | X | Appliance On - |
| | | | High Power |
| Appliance On | Discharged | No | Appliance On - |
| | | | Low Power |
| Appliance On | Discharged | Yes | Appliance On - |
| | | | High Power |

Such an implementation is particularly effective in application where it is desirable to allow the user to operate the appliance 124 as desired while conserving the life of the auxiliary batteries 106.

It will be understood that Tables I and II are examples and that other configurations are contemplated. By way of non-limiting examples, the user override function may be omitted, especially in applications where it is desirable to conserve the auxiliary batteries 106 and flexibility in the operation of the appliance 124 is relatively unimportant. Either or both of the converter circuit 116 or the appliance 124 may have additional or different modes. Still additionally, the state of charge detector 130 may detect additional or intermediate charge states, with the appliance 124 operating mode being adjusted among a corresponding or other number of different operating modes. As still a further example, the operating mode of the appliance 124 and/or the converter 116 may be adjusted substantially continuously based on the detected charge state. The mode or state adjustment may also be non-linear, for example by reducing the power level relatively less when the rechargeable energy storage device 112 is relatively more charged and relatively more as the rechargeable energy storage device 112 becomes increasingly discharged. Additionally or alternately, the modes or states may be adjusted as a function of the charge state of the auxiliary battery 106. For example, the modes may be also adjusted when the battery 106 becomes relatively discharged or when either of the battery 106 and the rechargeable energy storage device 116 becomes relatively discharged.

The state of charge of the rechargeable energy storage device 112 and/or the auxiliary battery 106 may also be indicated via the user interface 118 by way of a fuel gauge or other human visible indicator. The state of charge may also be indicated by varying an operation of appliance 124. Where the appliance includes a light source or a sound source, for example, the brightness of the light source or the output of the sound source may be temporarily reduced, stuttered, increased, or otherwise varied to indicate the rechargeable energy storage device 112, the auxiliary battery 106, or both, are becoming relatively discharged, with the rate and/or frequency of the variation being increased as the power source becomes increasingly discharged.

The apparatus 100 may also be configured to receive power from an external power source such as the standard alternating current (ac) power mains. As shown in FIG. 1, a connector such as a standard ac plug 129 connects to a power receptacle, while a power converter 126 converts the ac power to voltage and/or current levels suitable for the apparatus 100. Note that some or all of the power converter may be located physically external to the apparatus 100, for example in a receptacle mounted power cube or other power adaptor. Where external power is available, the rechargeable energy storage device 112 would ordinarily be charged at a relatively high rate using energy from the external source in preference to the auxiliary batteries 106.

The apparatus 100 is particularly well suited for use in connection with appliances 124 that present relatively high peak electrical loads but tend to be operated at relatively low duty cycles. In such an implementation, the rechargeable energy storage device 112 may have a relatively high peak load capability but a relatively low energy per unit volume (sometimes referred to as energy density and expressed in units such as watt-hours per liter (Wh/L)) and/or energy per unit weight (sometimes referred to as specific capacity and expressed in units such as watt-hours per kilogram (Wh/Kg)). The auxiliary battery, on the other hand, may have a relatively low peak load capability but a relatively high energy density and/or specific capacity.

For example, the rechargeable energy storage device 112 may include a nickel metal hydride (NiMH), lithium ion (Li Ion), Li Ion polymer, or other secondary battery, with the size, number and chemistry of the batteries being selected so that that the batteries can be expected to power the appliance 124 when operated according to normally anticipated usage patterns. The auxiliary batteries 106 may include alkaline, zinc air prismatic (ZAP), carbon-zinc batteries or other primary batteries which would ordinarily not be well-suited for supplying the peak loads presented by the appliance 124.

The battery chemistries and construction may also be selected so that the energy density and/or specific capacity of the auxiliary battery 106 are approximately equal to or greater than those of the battery 112. Zinc air battery chemistries, for example, typically have an energy density and specific energy greater than that of LiIon, LiIon polymer, and NiMH secondary chemistries. As another example, Lithium manganese dioxide (LiMNO₂) primary chemistries typically have an energy density that is approximately equal to or greater than Li Ion, NiMH, and LiMNO₂ chemistries. In the case of primary battery chemistries in which the specific energy or capacity is relatively discharge rate dependent (for example in the case of carbon zinc and somewhat less so in the case of alkaline batteries), the charge rate of the converter circuit 116 may be established so that the energy density and/or specific capacity of the primary batteries is greater than or equal to that of the battery 112. While doing so tends to improve the volumetric and/or weight characteristics of the appliance 102, it will also be understood that the appliance need not be so configured.

The size, number, and chemistry of the auxiliary batteries 106 and the charge rate of the converter circuit 116 are selected so that auxiliary batteries 106 can be expected to recharge the secondary batteries during periods in which the appliance is operated in a low power state or not in use.

In this sense, the rechargeable energy storage device 112 may be viewed as a reservoir which is slowly charged or filled using energy from the auxiliary batteries 106 and relatively more rapidly discharged or emptied by the appliance 124. As the rechargeable energy storage device 112 becomes relatively discharged, the available energy may be conserved by switching the appliance 124 to a lower power or extended use mode. On the other hand, it may in some situations be desirable to continue to operate the appliance 124 in a relatively high power mode while discharging the auxiliary batteries 106 at a relatively higher rate, potentially at the expense of shortened auxiliary battery 106 life.

The apparatus 100 may take various forms depending on its nature and function. For example, the apparatus 100 and appliance 124 may be configured as a human portable light source that provides ambient illumination such as a flashlight, a lantern style light, an area light, a wearable light such as a headlamp, or the like. The apparatus 100 may also include a suitable light management system. In the case of a device that produces a light beam of the sort produced by a conventional flashlight, the light management system may include a reflector and lens.

The light source may include one or more light emitting diodes (LEDs), incandescent bulbs, or other lamps. Where the light source contains more than one lamp, the various operating modes may be achieved by selectively illuminating the lamps in various combinations (e.g., 0 lamps on/3 lamps off, 1 on/2 off, 2 on/1 off, 3 on/0 off in the case of a light source having three lamps and three operating modes). The power applied to and hence the brightness of the light source may likewise be varied either continuously or in increments (e.g., off/low/hi, or off/low/med/high, or the like). The desired operating modes may also be achieved by varying a drive current applied to the LED(s), for example by introducing or changing the value of a current limit resistor, varying a current and/or voltage supplied by a control circuit, or the like. Variable duty cycle and other techniques are also contemplated.

The low power operating mode may also be established at or near the peak luminous efficiency of the light source. For lamps such as LEDs having a luminous efficiency that varies as a function of the applied current, for example, the low power operating state may be established at or near the current which provides the maximum luminous efficiency. The “low charge” level may be established so that the secondary energy storage device 112 or the battery 106 contains energy sufficient to operate the light source 120 for at least several (e.g., two, three, five, ten or more) minutes.

Other appliances 124 are also contemplated. Examples include portable devices, non-portable devices, cellular phones, personal digital assistants (PDA), notebook computers, smart phones, portable digital audio devices, multimedia devices, industrial and other measurement devices, bar code scanners, remote monitoring devices, device which produce a motion, thermal or other physical output, and the like. The appliance 124 may, as an example, include a cellular or wireless phone that has features extending beyond making and receiving voice calls, such as the ability to send and receive digital pictures and/or text messages, browsing the Internet, listening to music, watching video content and performing other multi-media functions. It is noted that the above features typically have differing levels of power consumption. The apparatus 100 may also include more than one appliance 124.

Still other variations are contemplated. Thus, for example the auxiliary battery receiving region 104 may be configured to receive auxiliary batteries 106 of different sizes so that the user may select among batteries which are ready to hand.

The apparatus 100 may also include a thermostatically controlled or other heater powered by the rechargeable energy storage device 112 and in operative thermal communication with the auxiliary battery 106. Such an arrangement is particularly beneficial in the case of auxiliary batteries 106 having an aqueous electrolyte or where it is otherwise desirable to improve the low temperature performance of the auxiliary batteries 106.

The load presented to the auxiliary battery 106 may be varied as a function of the charge state of the rechargeable energy storage device 112 and the power being drawn by the appliance 124. This may be performed, for exampling, using the known TEC103 hybrid charge controller integrated circuit available from Techtium, Ltd of Tel Aviv, Israel.

As still another variation, the apparatus 100 may include a transducer that receives auxiliary energy that is provided to the circuit 116 or otherwise for charging the secondary energy storage device. The apparatus 100 may thus include one or more of solar cells, generators or other devices that convert a mechanical input from a hand or other crank, or pneumatic, hydraulic, or other fluidic inputs to electrical energy, or other suitable devices.

Note that the various functions described above may be performed using analog or digital electrical circuitry, or software or firmware running on a suitable processor, either alone or in various combinations, or other suitable techniques.

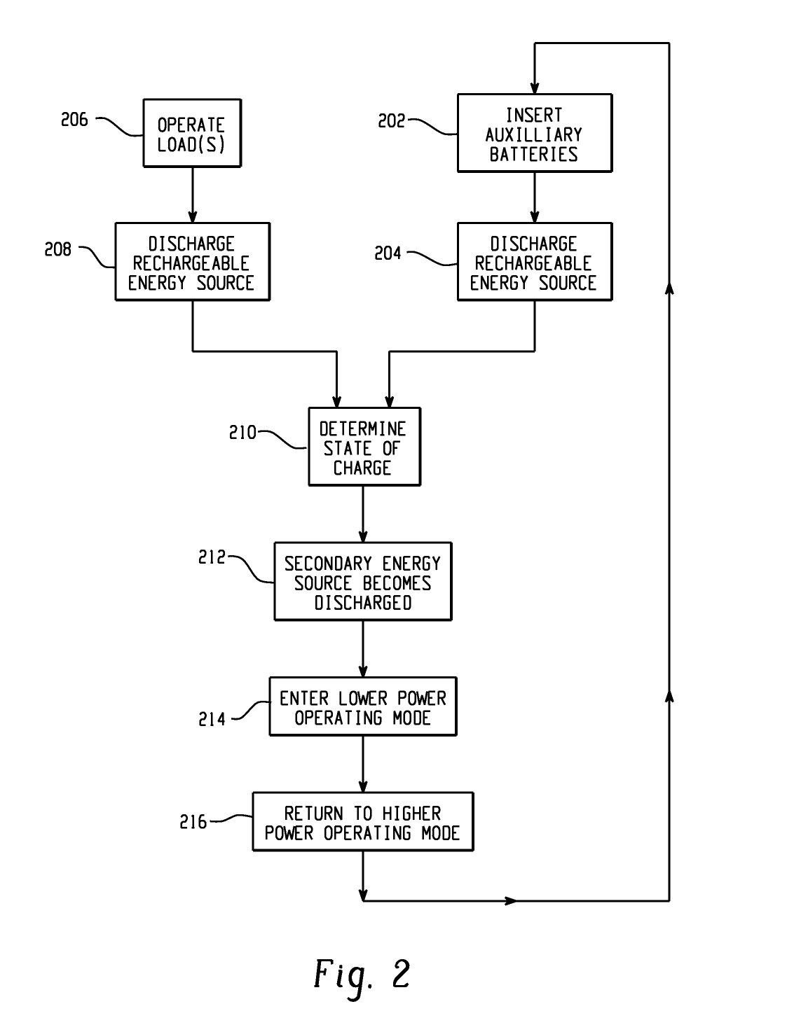

Operation of an example embodiment of the device will now be described in relation to FIG. 2.

The auxiliary battery(ies) 106 is inserted at step 202.

The rechargeable energy storage device 112 is charged as needed at step 204, for example to increase the charge state of the storage device 112 or to compensate for the effects of self-discharge.

At 206, the user may decide to operate the appliance 124 temporally concurrently with the charging of the rechargeable energy storage device. In the case of a light source and depending on its functionality, the user may turn the light source on and off, adjust its brightness, or the like. Note that, in the present example, the charging of the rechargeable power source also occurs where the appliance 124 is turned off.

For the purpose of the present explanation, it will be assumed that the operating mode of and/or duty cycle presented by the appliance 124 is such that the rate of discharge of the secondary energy storage device 112 is greater than the rate of charge. By way of example, the rate of charge may be such that a substantially fully discharged rechargeable energy storage device 112 may be expected to be fully charged in a period of twelve (12) to twenty four (24) hours, whereas the rate of discharge may be such that the rechargeable energy storage device 112 would be expected to become discharged after a period of one (1) to two (2) hours of operation. Hence, the rechargeable energy storage device 112 becomes tends to become discharged as indicated at 208.

The state of charge of one or both of the auxiliary battery 106 and the rechargeable energy storage device 112 is determined at 210. Where the apparatus 100 is so configured, the state of charge information is presented to the user. Assuming that the user does not alter the operating mode of the appliance 124, the rechargeable energy storage device 112 becomes relatively discharged at step 212.

At 214, the appliance 124 enters a relatively lower power, extended use operating mode. Where the relatively lower power operating mode is such that the power drawn by the appliance 124 is less than the power provided by the auxiliary battery 106, the rechargeable energy storage device 124 becomes relatively more charged.

At 216, the user may elect to return the appliance 124 to a relatively higher power operating state. Where the power drawn by the appliance 124 is greater than the power provided by the auxiliary battery 106, the rechargeable energy storage device 112 continues to be discharged. Note that, as described above, the apparatus 100 may also be configured so that the auxiliary battery 106 provides energy at a relatively greater rate. While such a situation will ordinarily result in the less efficient utilization of the auxiliary battery 106, the appliance will continue to operate until the auxiliary battery 106 becomes discharged.

The user may elect to return to step 202 when the auxiliary batteries 106 become discharged or otherwise as desired.

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A battery powered apparatus comprising:
a rechargeable energy storage device;
a battery receiving region;
an appliance that receives energy from the rechargeable energy storage device, wherein the appliance includes a first operating mode and a second, relatively lower power operating mode;
a circuit that uses energy from a battery received in the battery receiving region to charge the rechargeable energy storage device;
a state of charge detector that detects a state of charge of the rechargeable energy storage device;
a mode controller that changes the operating mode of the appliance as a function of the detected state of charge.

2. The battery powered apparatus of claim 1 wherein in the rechargeable energy storage device has a first maximum rate capability and a battery received in the battery receiving region has a second maximum rate capability, wherein the first maximum rate capability is greater then the second maximum rate capability.

3. The battery powered apparatus of claim 1 wherein the rechargeable energy storage device has a first energy per unit volume and a battery received in the battery receiving region has a second energy per unit volume, and wherein the first energy per unit volume is less than the second energy per unit volume.

4. The battery powered apparatus of claim 1 wherein the rechargeable energy storage device has a first energy per unit weight and a battery received in the battery receiving region has a second energy per unit weight, and wherein the first energy per unit weight is less than the second energy per unit weight.

5. The battery powered apparatus of claim 1 wherein the discharge time of the rechargeable energy storage device when the appliance is operated in the first operating mode is shorter than the charge time of the rechargeable energy storage device.

6. The battery powered apparatus of claim 1 wherein the rechargeable energy storage device includes a secondary battery and the battery received in the battery receiving region is one of a zinc air, alkaline, or carbon zinc battery.

7. The battery powered apparatus of claim 1 wherein the appliance includes an off state and the circuit uses energy from the battery to recharge the rechargeable energy storage device when the appliance is in the off state.

8. The battery powered apparatus of claim 1 wherein the power drawn by the appliance when the appliance is in the first operating mode is greater than a power supplied by the circuit.

9. The battery powered apparatus of claim 1 wherein the second operating mode is an extended use operating mode and the mode controller causes the electrical appliance to automatically enter the extended use mode.

10. The battery powered apparatus of claim 9 further including an override function that allows the user to override an entry of the appliance into the second operating mode and cause the appliance to enter a relatively higher power operating mode.

11. The battery powered apparatus of clam 1 further including a user interface that indicates the state of charge of the rechargeable energy storage device and an override function that allows the user to cause the appliance to enter the second operating mode.

12. The battery powered apparatus of claim 1 wherein the energy efficiency of the appliance varies as a function of the operating mode and the second mode is a mode in which the appliance operates substantially at a maximum energy efficiency.

13. The battery powered apparatus of claim 1 wherein the apparatus includes one of a flashlight, a human portable area light, or a human wearable light.

14. The battery powered apparatus of claim 1 wherein the appliance includes a plurality of lamps and wherein, when the appliance is in the second operating mode, at least one of the lamps produces an illumination less than the illumination produced by the at least one lamp when the appliance is in the first operating mode.

15. The battery powered apparatus of claim 1 including a housing, wherein the rechargeable energy storage device, the electrical appliance, circuit, state of charge detector, and mode controller are carried by the housing.

16. A method comprising:
using energy from a battery received in a battery receiving region of a battery powered apparatus to charge a rechargeable energy storage device of the battery powered apparatus at a first rate;
using energy from the rechargeable energy source to operate an electrical appliance of the device in a first operating mode that discharges the rechargeable energy storage device at a second rate, wherein the first rate is lower than second rate;
causing, as a function of the state of charge of the rechargeable energy storage device, the appliance to enter a second operating mode that discharges the rechargeable energy storage device at a third rate, wherein the third rate is lower than the second rate.

17. The method of claim 16 wherein the third rate is approximately equal to the first rate.

18. The method of claim 16 including performing the step of using energy from the battery while the electrical appliance is turned off.

19. The method of claim 18 including performing the steps of using energy from the battery and using energy from the rechargeable energy source temporally concurrently.

20. The method of claim 16 wherein causing includes automatically causing the appliance to enter the second operating mode.

21. The method of claim 20 including causing, as a function of an input from a human user, the device to enter a third operating mode that discharges the second rechargeable energy storage device at a fourth rate, wherein the fourth rate is less than or equal to the second rate.

22. The method of claim 16 including informing a human user that the rechargeable energy storage device has become relatively discharged and wherein causing includes causing the appliance to enter the second operating mode in response to an input from the human user.

23. The method of claim 16 wherein determining includes comparing the state of charge to a threshold value.

24. The method of clam 16 including increasing the first rate based on an input from a human user.

25. The method of claim 16 including increasing the first rate to a value that is approximately equal to the second rate.

26. The method of claim 16 wherein the rechargeable energy storage device includes a capacitive energy storage device.

27. The method of claim 16 wherein the battery is a primary battery and the rechargeable energy storage device includes a lithium ion or a nickel metal hydride battery.

28. The method of claim 16 including determining the state of charge of the battery.

29. An apparatus comprising:
a battery receiving region that receives a first battery;
a rechargeable energy storage device that receives energy from the first battery;
an appliance that receives energy from the rechargeable energy storage device and includes a first operating mode and an extended use operating mode;
a mode controller that causes the electrical appliance to enter the extended use mode based on a state of charge at least one of the rechargeable energy storage device and the first battery.

30. The apparatus of claim 29 wherein the first battery is of a first battery chemistry, the rechargeable energy storage device includes a second battery of a second battery chemistry having a maximum rate capability that is greater than the maximum rate capability of the first chemistry, and the energy per unit weight of the first battery chemistry is greater than the energy per unit weight of the second battery chemistry.

31. The apparatus of claim 29 wherein the apparatus includes a user interface that provides a user perceptible output when the secondary energy storage device has become relatively discharged and the mode controller causes the electrical appliance to enter the extended use mode in response to an input from the user interface.

32. The apparatus of claim 29 wherein the mode controller causes the electrical appliance to automatically enter the extended use mode when the secondary energy storage device becomes relatively discharged.

33. The apparatus of claim 29 wherein the appliance draws a first power when operating in the extended use mode, the device includes a user interface, and the mode controller causes the appliance to enter a third operating mode in which the appliance draws an operating power greater than the first power.

34. The apparatus of claim 33 wherein the third operating mode is the same as the first operating mode and the user interface is a switch.

35. The apparatus of claim 29 including a heater that heats the battery.

36. The apparatus of claim 29 including a charger circuit that uses energy from the battery to charge the rechargeable energy storage device.

37. The apparatus of claim 29 including a transducer that converts a light energy or a mechanical energy to electrical energy, and wherein the electrical energy is used to charge the rechargeable energy storage device.

38. The apparatus of claim 29 wherein the apparatus is a flashlight.
